(19) United States
(12) Patent Application Publication
(10) Pub. No.: US 2014/0170390 A1
(43) Pub. Date: Jun. 19, 2014

(54) TEMPERED GLASS AND METHOD OF TEMPERING GLASS

(71) Applicant: HON HAI PRECISION INDUSTRY CO., LTD., New Taipei (TW)

(72) Inventor: SEI-PING LOUH, New Taipei (TW)

(73) Assignee: HON HAI PRECISION INDUSTRY CO., LTD., New Taipei (TW)

(21) Appl. No.: 13/749,569

(22) Filed: Jan. 24, 2013

(30) Foreign Application Priority Data
Dec. 17, 2012 (TW) 101147749

(51) Int. Cl. C03C 17/32

(52) U.S. Cl. CPC C03C 17/32
USPC 428/167; 65/31; 65/60.3; 427/309

(57) ABSTRACT

A tempered glass includes a glass substrate and a glue. The glass substrate includes a first surface and a second surface opposite to the first surface, and defines a plurality of strip recesses regularly arrayed on the first surface. The glue is infilled into the strip recesses to be coplanar with the first surface. The refractive index of the glue is substantially equal to the refractive index of the glass substrate.

### BACKGROUND

1. Technical Field

The present disclosure relates to glass, and particularly, to a tempered glass and a method of tempering glass.

2. Description of Related Art

Methods of tempering glass generally include a chemical tempering method and a physical tempering method. The chemical tempering method needs to accurately control concentration of K⁺ of solution, and the physical tempering method needs to accurately control heating temperature of the glass, both of which are complicated.

Therefore, it is desirable to provide a tempered glass and a method of tempering glass, which can overcome the limitations described.

### BRIEF DESCRIPTION OF THE DRAWINGS

FIG. 1 is a cross-sectional view of a tempered glass in accordance with an exemplary embodiment.

FIG. 2 is a flow chart of a method of tempering a glass of FIG. 1 in accordance with another exemplary embodiment.

### DETAILED DESCRIPTION

Embodiments of the disclosure will be described with reference to the drawings.

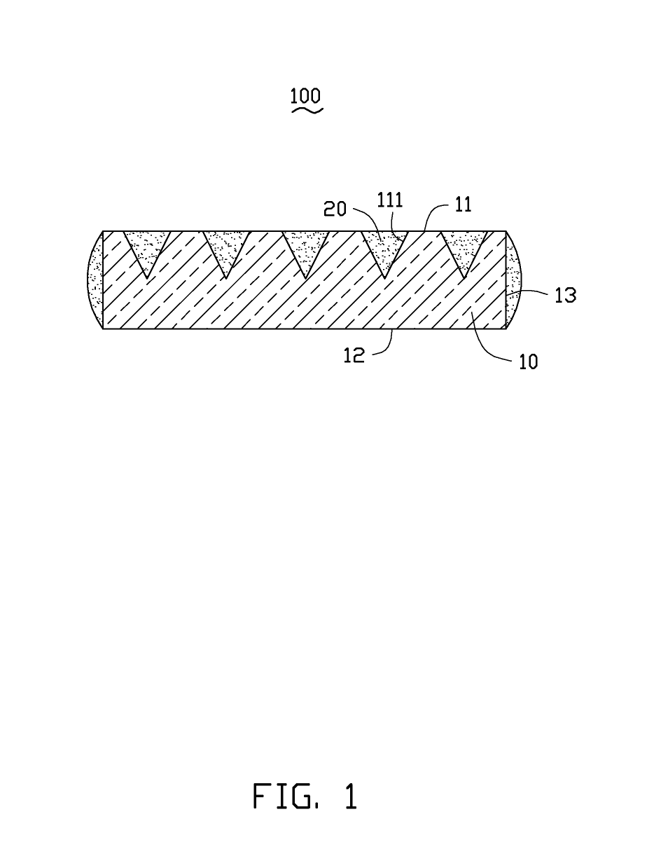

FIG. 1 shows a tempered glass 100 according to an exemplary embodiment. The tempered glass 100 includes a glass substrate 10 and glue 20.

The glass substrate 10 is cut from a common glass. The glass substrate 10 includes an first surface 11 (i.e., an upper surface as shown in FIG. 1), a second surface 12 (i.e., a lower surface as shown in FIG. 1) opposite to the first surface 11, and a third surface 13 (i.e., a side surface as shown in FIG. 1) connected between the first surface 11 and the second surface 12. The glass substrate 10 defines a number of strip recesses 111 on the first surface 11. The strip recesses 111 are regularly arrayed on the first surface 11. In other embodiments, the strip recesses 111 can be instead formed on the second surface, or on both of the first surface 11 and the second surface 12.

A width of the strip recesses 111 (i.e., a length measured along a direction perpendicular to an extending direction of the strip recesses 111) is greater than about 100 nm and less than about 500 nm. If the width of the strip recesses 111 is less than about 100 nm, improvement of toughness, shock resistance, and hardness of the glass substrate 10 may not be achieved. If the width of the strip recesses 111 is greater than about 500 nm, toughness, shock resistance, and hardness of the glass substrate 10 may be decreased.

In this embodiment, the strip recesses 111 are evenly spaced on the first surface 11. A cross-section of the strip recesses 111 along a direction perpendicular to an extending direction of the strip recesses 111 is V-shaped or semi-cylindrical.

The glue 20 is polymethyl methacrylate or epoxy resin, the refractive index of the glue 20 is substantially equal to the refractive index of the glass substrate 10. The glue 20 is infilled in the strip recesses 111, and the level of the glue 20 is coplanar with the first surface 11 of the glass substrate 10. The glue 20 covers the third surface 13 of the glass substrate 10, and the glue 20 infills cracks which may be formed on the third surface 13 when the glass substrate 10 is cut. The glue 20 solidifies or is solidified after the strip recesses 111 have been infilled.

In use, the first surface 11 of the tempered glass 100 faces the outside. When an external force is applied to the tempered glass 100, the tempered glass 100 is stronger as the first surface 11 is strengthened. Therefore, the tempered glass 100 acts to protect anything or any person inside the tempered glass 100.

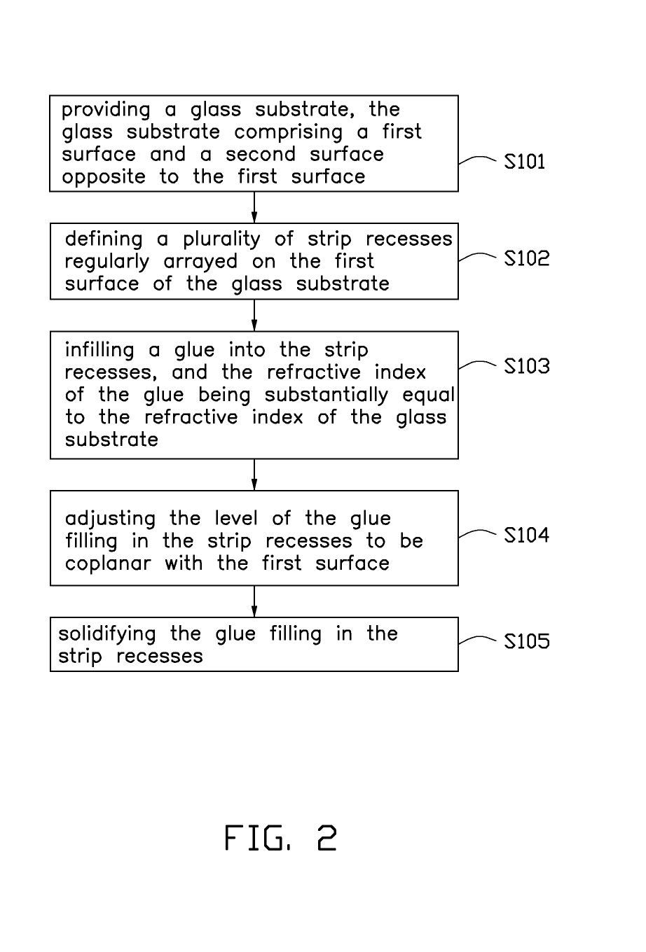

FIG. 2 shows a tempering method, according to an exemplary embodiment. The tempering method strengthens the tempered glass 100. The tempering method includes steps of S101-S105.

S101: a glass substrate 10 is provided, the glass substrate 10 includes an first surface 11, a second surface 12 opposite to the first surface 11, and a third surface 13 connected between the first surface 11 and the second surface 12.

S102: the glass substrate 10 defines a number of strip recesses 111 regularly arrayed on the first surface 11. In this embodiment, the strip recesses 111 are defined by chemical etching, high temperature melting, or electrical discharge machining processes.

S103: the glue 20 is infilled into the strip recesses 111 of the first surface 11 and also covers the third surface 13. The glue 20 is polymethyl methacrylate or epoxy resin, the refractive index of the glue 20 is substantially equal to the refractive index of the glass substrate 10. In this embodiment, the glue 20 is stored in a number of evenly spaced sprayers, the distance between two adjacent sprayers is equal to the distance between two adjacent strip recesses 111. The sprayers move along an extending direction of the strip recesses 111, and the glue 20 is sprayed from the sprayers to infill the strip recesses 111.

S104: the level of the glue 20 filling the strip recesses 111 is adjusted to be coplanar with the first surface 11.

S105: the glue 20 filling the strip recesses 111 and covering the third surface 13 solidifies or is solidified.

The glass substrate 10 defines a number of strip recesses 111, and the glue 20 is infilled in the strip recesses 111, therefore any fissures on the first surface 11 are also infilled and thus canceled. Furthermore, as the refractive index of the glue 20 is substantially equal to the refractive index of the glass substrate 10, the optical properties of the tempered glass 100 will not be changed.

Particular embodiments are shown and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

1. A tempered glass, comprising:
a glass substrate comprising a first surface and a second surface opposite to the first surface, and defining a plurality of strip recesses regularly arrayed in the first surface; and
a glue infilled into the strip recesses, and the refractive index of the glue being substantially equal to the refractive index of the glass substrate.

2. The tempered glass of claim 1, wherein the substrate comprises a third surface connected between the first surface and the second surface, and the glue covers on the third surface.

3. The tempered glass of claim 1, wherein a cross-section of the strip recesses along a direction perpendicular to an extending direction of the strip recesses is V-shaped or semi-cylindrical shaped.

4. The tempered glass of claim 1, wherein a width of the strip recesses along a direction perpendicular to an extending direction of the strip recesses is greater than about 100 nm and less than about 500 nm.

5. The tempered glass of claim 1, wherein the glue is polymethyl methacrylate or epoxy resin.

6. The tempered glass of claim 1, wherein the level of the glue is coplanar with the first surface of the glass substrate.

7-10. (canceled)
